(19) United States
(12) Patent Application Publication
(10) Pub. No.: US 2005/0058390 A1
(43) Pub. Date: Mar. 17, 2005

(54) Optical fiber network system transmission method, optical fiber network system thereof, and central unit thereof

(76) Inventor: Masashi Iwai, Aichi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/489,609

(22) PCT Filed: Sep. 19, 2002
(86) PCT No.: PCT/JP02/09657

(30) Foreign Application Priority Data
Sep. 20, 2001 (JP) 2001-284461

(51) Int. Cl. G02B 6/26

(52) U.S. Cl. 385/15

(57) ABSTRACT

A passive optical network (PON) comprising optical fibers and optical couplers. An central equipment 10 comprises a hub 16, plural modems 17, a mixer 18, and a splitter 19. Carrier waves of a predetermined frequency are assigned to the plural modems 17 and each customer equipment 60. In the downstream, the hub 16 selects each modem 17 (that is, each customer equipment 60) and converts the assigned carrier wave into modulated signals. The modulated signals are mixed in the mixture 18, converted into frequency-multiplexed signals, and transmitted through a first optical coupler 52 to the customer equipment 60. Each customer equipment 60 demodulates the signals by using carrier waves of the assigned frequency. In the upstream, a first optical coupler 53 converts signals from each customer equipment 60 into frequency-multiplexed signals and transmits to the central equipment 10. In the central equipment 10, the splitter 19 branches the signals per each carrier wave of the assigned wavelength, and each modem 17 demodulates the signals. As a result, a passive optical network (PON) is realized.

### TECHNICAL FIELD

The present invention relates to an optical fiber network system communication method, its optical fiber network system and a central equipment used in the system. More particularly, the present invention relates to a communication method, its optical fiber network system and its central equipment, which comprises a passive type optical coupler in a conventional central equipment and/or a repeater unit and which transmits and receives optical signals modulated in Ethernet (registered trademark) standard through the optical coupler.

The present invention can be applied to a CATV optical fiber network system which supplies TV signals and data transmission.

### BACKGROUND ART

Conventionally, a CATV network system providing image signals, data signals of Internet service, etc. through optical fibers has been known. A conventional CATV network system provides image signals, digitized image data, audio data, and character data for Internet service in addition to TV signals. FIG. 10 shows such a network system. The conventional system consists of a central equipment 10, optical fiber 21, 22, and 23, a repeater unit 30, optical fiber 41, 42, and 43, and customer equipments which are not illustrated. The central equipment 10 consists of an image unit 11 which generates image signal, an optical transmitter 12 which converts image signal into optical signal and transmits, a router 13 which inputs and outputs data signal in Ethernet standard from and to other network systems, an optical transmitter 14 which converts data signal in Ethernet standard into optical signal and transmits the signal, and an optical receiver 15 which receives optical signal from customer equipments and converts into electric signal.

A repeater unit 30 consists of an optical coupler 31 which branches/distributes image signal transmitted through the optical fiber 21 to the customer equipments, an optical receiver 33 which receives data signal transmitted from the central equipment 10 through the optical fiber 22 and converts into optical signal, an optical transmitter 34 which converts data signal into electric signal and transmits to the central equipment 10, a hub 35 which is a line concentrator and integrates and distributes data signal of Ethernet standard, an optical transmitter 36 and an optical receiver 37 which are installed at input-and output ports of the downstream side of the hub 35, respectively.

In the network structure described above, the repeater unit 30 functions as a branch point of transmission line which branches/distributes image signal to each customer equipment, integrates and distributes the data signal. That is, image signal is branched/distributed through the optical coupler 31 and the optical fiber 41 in the repeater unit 30, and data signal is mixed and distributed by the hub 35, the optical fiber 42 and 43. In short, image signal and data signal are transmitted in each separate route. Moreover, data signal (optical signal) is once converted into electric signal, distributed by the hub 35, then again converted into optical signal and transmitted through plural optical fibers.

### DISCLOSURE OF THE INVENTION

However, problems persist in the conventional optical fiber network system. In the conventional optical fiber network system, image signal and data signal are transmitted through separate network system. That makes transmission route complicated.

Additionally, in the conventional network system, optical signal is once converted into electric signal in a repeater unit, distributed by a hub, converted into optical signal again and then transmitted. In order to transmit data signal, electric power supply is needed at a branch point. Accordingly, the conventional network system cannot be a perfect Passive Optical Network which reduces communication cost.

Accordingly, in light of the above problems, an object of the present invention is to branch/distribute and mix data signal to each customer equipment through optical coupler, thereby to obtain Passive Optical Network with less communication cost.

Other object of the present invention is to prepare carrier waves of multiple frequency bands, assign them to each customer equipment and to carry out data communication by using the carrier waves in multiple frequency bands, thereby to obtain the above-described Passive Optical Network using the above described optical coupler.

Other object of the present invention is to overlap image signal to data signal, thereby to realize a perfect Passive Optical Network in which the both signal can be used and to further improve its convenience.

Here each of the objects described above is to be achieved by each individual invention, and it is to be understood that each individual invention does not achieve all the objects described above.

In order to achieve the above object, a first aspect of the present invention is a communication method of optical fiber network system which connects a central equipment and customer equipments, comprising a first optical coupler at a branch point of the central equipment and/or optical fiber network system. The first optical coupler branches/distributes optical fiber to the customer equipments. Carrier waves having multiple bands are prepared in at least upstream route of the network system and each is assigned to each customer equipment. The customer equipments modulate carrier waves of assigned bands into Ethernet standard and transmit the carrier waves in frequency-division multiplex to the upstream route of the network system through the first optical coupler.

This optical fiber network system comprises a first optical coupler at a branch point of the central equipment and/or the optical fiber network system. The first optical coupler branches/distributes optical fiber cables to each customer equipment, respectively.

In this network system, at least in the upstream signal line of this network system, carrier waves of plural frequency bands are provided. An optical fiber can transmit data of several GHz. For example, the carrier waves are arranged to have frequency band of several GHz, each band is assigned to each customer equipment. The customer equipment then modulates the carrier waves of several GHz in Ethernet standard and transmits to the upstream side. Accordingly, there is no limitation in the period of transmitting signals to the upstream route, and that enables each of customer equipment to transmit data signals through the channel which is assigned to each of customer equipment or through the unoccupied channel.

A second aspect of the present invention provides a communication method of optical fiber network system according to the first aspect, wherein the central equipment modulates carrier waves of a predetermined band in carrier waves of multiple bands in Ethernet standard and transmits the frequency-multiplexed signals through the downstream route.

That is, carrier waves of multiple bands are modulated to be frequency-multiplexed signals and the modulated signals are transmitted through both of the upstream signal route and the downstream signal route.

For example, when the first optical coupler is installed in the central equipment, the modulated signals are transmitted by the branching fiber directly to each of customer equipment. A customer equipment demodulates the modulated data in an assigned and predetermined frequency band in order to receive the data.

For example, when the first optical coupler is installed at a branch point of the trunk optical fiber cable, carrier waves of the predetermined band are modulated by the central equipment in Ethernet standard to be frequency-multiplexed signals and sent to the trunk optical fiber cable. The first optical coupler is installed at a branch point of The trunk optical fiber cable and the first optical coupler branches/distributes the frequency-multiplexed signals to each customer equipment. The customer equipment uses the assigned carrier waves of predetermined frequency band to demodulate the frequency-multiplexed signals, to thereby obtain data signals in Ethernet standard.

On the contrary, when the customer equipment transmits data to the upstream, the assigned carrier waves of predetermined frequency band are modulated to the data signals in Ethernet standard and transmitted through the branching fiber to the first optical coupler. The first optical coupler multiplexes frequency of the modulated signals which are sent from each customer equipment and transmits the frequency-multiplexed signals to the central equipment. Then the central equipment demodulates the frequency-multiplexed signals from each customer equipment by using the assigned carrier waves of predetermined frequency. Accordingly, the central equipment receives information data from each customer equipment.

As described above, all the lines which connect the central equipment and the customer equipment through the passive first optical coupler are optical fibers in the communication method of the present invention. That is, all data communication between the central equipment and the customer equipment is carried out by using optical signals. As a result, the central equipment and the customer equipment in the present invention can be connected by the fastest data communication method. Moreover, because the first optical coupler needs no electric power supply, a network system with excellent cost performance can be obtained in the present invention. Here the data includes all digitalized data such as image data, text data, and sound data.

A third aspect of the present invention provides a communication method of optical fiber network system according to the second aspect, wherein the central equipment and the customer equipment search an unoccupied band from multiple bands and use the carrier wave of the unoccupied band to transmit frequency-division multiplex.

The central equipment and the customer equipment are not constantly connected for data communication. That is, there is an unoccupied band (vacant band) in the data communication line. On starting data communication, for example, the central equipment and the customer equipment start data communication at first by searching for unoccupied band in the multiple frequency bands of the carrier waves. Here unoccupied frequency band is the band which is not used for data communication at that period. And data communication is carried out through carrier wave of the unoccupied frequency band. As a result, larger number of customer equipments can connect to the network than the number of multiple bands. Moreover, that results in improving efficiency of utilizing frequency. Accordingly, data communication can be provided efficiently to larger number of customer equipments by employing the communication method of the present invention.

A fourth aspect of the present invention provides a communication method of optical fiber network system according to the second aspect, wherein each of the multiple bands is assigned and fixed to each of customer equipment and the central equipment and the customer equipment use carrier waves of the assigned predetermined frequency to transmit signals in the frequency-division multiplex.

In the communication method of the present invention, each of the multiple bands in the network is assigned and fixed to each customer equipment. That is, it is already determined for the central equipment and the customer equipment which carrier wave to use, and it is not necessary for the central equipment and the customer equipment to search for unoccupied band. That enables the central equipment and the customer equipment to carry out data communication immediately. As a result, an excellent data communication network with no waiting time can be obtained. Such a network can be utilized especially to an important dedicated line communication network such as a disaster prevention system and a security system using optical fiber.

A fifth aspect of the present invention provides a communication method of optical fiber network system according to any one of the first to fourth aspects, wherein the modulation method of frequency-division multiplex is any one of amplitude modulation or amplitude shift keying method, frequency modulation method and, or a combination of those methods.

The amplitude shift keying (ASK) method enables to detect the envelope, so data can be demodulated easily. With respect to the frequency shift keying (FSK) modulation method, the signals modulated by the method has no amplitude information. As a result, data communication of the frequency shift keying (FSK) modulation method is hardly affected by signal level fluctuation and noise, which helps to obtain stable data demodulation. And because phase-modulation or phase-shift keying (PSK) method only varies phase of the signals, their spectrum is not so much broadened and that enables to transmit data with using frequency band more efficiently. Further, by employing PSK method, data transmission is hardly affected by signal level fluctuation and noise similar to data communication employing the FSK modulation method.

Alternatively, a combination of ASK method and PSK method, or APSK method, may be employed. APSK method is a method of modulating amplitude and phase simultaneously. Because APSK method can assign data signals to two-dimensional signal spaces, or amplitude and phase, efficiency of utilizing frequency can be improved. ASK method, FSK method, and PSK method employ binary modulation. Alternatively, those methods may employ multivalued modulation. That enables to narrow the interval between each band, resulting in increasing the number of branching/distributing lines, or increasing the number of customer equipments. That is, such a network can communicate with much more customer equipments.

A sixth aspect of the present invention provides a communication method of optical fiber network system according to any one of the first to fifth aspects, wherein the central equipment mixes the signals of the frequency-division multiplex modulated in Ethernet standard with other signals transmitted to the downstream direction. Here the signals includes the signals used in a conventional invention, e.g., TV signals, CATV broadcasting signals, downstream signals dedicated for CATV, and isochronous signals in IEEE 1394 standard.

For example, with respect to the other downstream signals described above, image signals are transmitted in a frequency band of 70 MHz to 770 MHz while data signals are transmitted in a frequency band of 900 MHz to several GHz. The other downstream signals are mixed in a unit, e.g., a mixer installed in the central equipment and transmitted as an optical signal. By employing such a communication method, a customer equipment may install only a directional filter at the downstream side of the optical receiver in addition. When the directional filter is installed in the customer's network, the optical signals transmitted from the mixer of the central equipment can be separated into original data signals, to thereby obtain other downstream signals, e.g., TV signals, in addition to data signals. Accordingly, a useful communication method can be obtained.

A seventh aspect of the present invention provides a communication method of optical fiber network system according to any one of the first to sixth aspects, when the first optical coupler is installed at the branch point of the optical fiber network system, wherein a pair of second optical couplers which mixes/separates optical signals having different wavelengths is installed at the downstream side of the central equipment and at the upstream side of the first optical coupler, or at the downstream side of the central equipment and at the upstream side of the customer equipment, sandwiching the first optical coupler with the former second optical coupler, the pair of second optical couplers are connected by one optical line, and data communication is carried out through the one optical line in a first predetermined wavelength to the downstream direction and in a second predetermined wavelength to the upstream direction.

Such a data communication system is applied to a network structure in which a first optical coupler is installed at a branch point in an optical fiber network system. For example, the second optical couplers which mix/separate optical data having different wavelengths, respectively, are installed. One of the second optical couplers is installed at the downstream side of the central equipment and at the other is installed at the upstream side of the first optical coupler so that the pair of the second optical couplers face with each other. And the pair of second optical couplers are connected with one optical line.

When the pair of second optical couplers are installed at the downstream side of the central equipment and at the upstream side of the customer equipment so that the pair of second optical couplers face with each other sandwiching the first optical coupler, the two second optical couplers are also connected with one optical line.

The former connection of the pair of second optical couplers means that the central equipment and the branch point are connected with one optical line (optical fiber), while the latter connection means that the central equipment and the customer equipment are connected with one optical line sandwiching the first optical coupler.

An optical coupler includes an optical branching device and an optical distributing device which only branches or distributes optical signals, a wavelength selecting device which selects a direction to separate according to a wavelength of signal, and a polarized wave device which preserves and separates polarized wave plane. In the present invention, the first optical coupler functions as an optical distributing device or an optical branching device which distributes/branches optical signals regardless to their wavelengths while the second optical coupler functions as a wavelength selecting device (directional filter) which separates optical signals in a predetermined wavelength to a predetermined direction.

In the above network structure, when a pair of the second optical couplers are installed at the downstream side of the central equipment and at the upstream side of the first optical coupler, optical signals with a first predetermined wavelength (e.g., 1.3 μm) which are transmitted to the downstream direction from the central equipment are inputted through the second optical coupler installed at the downstream side of the central equipment and facing to the other second optical coupler to one optical fiber. The inputted optical signals are branched to a predetermined direction (the side of the customer equipment's receiver) by the second optical coupler which functions as a directional filter. The separated optical signals are then transmitted by the first optical coupler and downstream branching fibers to each of the customer equipments. On the contrary, optical signals in a second predetermined wavelength (e.g., 1.55 μm) which are transmitted to the upstream direction from each customer equipment through upstream branching fibers, pass through the first optical coupler and the second optical coupler, and inputted to one optical line (optical fiber). Finally, the signals from the customer equipments are separated by the second optical coupler installed at the downstream side of the central equipment to a predetermined direction (the side of the receiver in the central equipment) and are received by the central equipment.

When a pair of second optical couplers are placed at the downstream side of the central equipment and at the upstream side of the customer equipment so that the pair of second optical couplers sandwich the first optical coupler, optical signals which are transmitted from the central equipment with a first predetermined wavelength (e.g., 1.3 μm) are transmitted by the second optical coupler installed at the downstream side of the central equipment to one optical fiber, and then inputted to the first optical coupler. The inputted optical signals are distributed through the first optical coupler and one branching fiber to each of the customer equipments. At the end of each branching fiber, or at the upstream end of the customer equipment's side, the second optical coupler is installed. The optical signals inputted to the second optical coupler are separated to a predetermined direction (the receiver side of the customer's network). That is, the signals transmitted from the central equipment pass through the first optical coupler to each of the customer equipments in a first predetermined wavelength.

On the contrary, optical signals which are transmitted from each customer equipment to the upstream side in a second predetermined wavelength (e.g., 1.55 μm) are transmitted through the second optical coupler, one branching fiber, the first optical coupler, one optical fiber (trunk), and the second optical coupler installed at the downstream side of the central equipment in sequence, and finally sent to the receiver side of the central equipment. That is, the central equipment and each of customer equipment communicate through one optical line. In a conventional invention, data communication had been carried out through two optical fibers (upstream line and downstream line). In the present invention, however, by employing a pair of second optical couplers, data communication can be carried out through one optical fiber at least between the pair of second optical couplers.

Because the two second optical couplers are connected through one optical line, an optical fiber network system employing such a structure becomes simpler compared with a conventional optical fiber network system. Through the one optical line (optical fiber), the optical signals in the first predetermined wavelength and the optical signals in the second predetermined optical wavelength are mixed and are transmitted as wavelength-division multiplexing signals.

Because data signals are transmitted through one optical line in frequency-multiplexed signals, data communication cost can be decreased. When the second optical coupler is installed at the upstream side of each customer equipment, the first optical coupler and the customer equipment are connected by one line, which halves processes for data communication. That also enables to decrease communication cost.

An eighth aspect of the present invention provides a communication method of optical fiber network system according to any one of the first, third and seventh aspects, wherein the central equipment are transmitted as time-division multiplex with respect to the downstream signals of the optical fiber network system.

Alternatively, downstream signals may be transmitted as time-division multiplexing signals. For example, time-division multiplexing signals may be transmitted in a frequency band which is higher than downstream image signal band. In short, efficiency of the present invention can be obtained by any one of assigning each band to each customer equipment and assigning unoccupied band to each customer equipment, that is, by employing a frequency-multiplexed network system.

A ninth aspect of the present invention provides an optical fiber network system comprising a central equipment and customer equipments, which comprises: a first optical coupler installed at the central equipment and/or at a branch point of an optical fiber extended from the central equipment; a branching fiber extended from the first optical coupler; and modems installed at the central equipment and each of the customer equipments, each of which transmits signal by each of carriers assigned to the respective customer equipments in frequency-division multiplex through the first optical coupler.

This network system is a passive optical fiber network system (passive optical network) which comprises the first optical coupler at the branch point of the central equipment and/or the optical fiber extended from the central equipment and transmits optical signals to each customer equipment through branching fiber without amplifying the signals. In this network system, carrier waves of multiple bands are prepared and assigned to each customer equipment. The carrier waves of the assigned band are modulated in, for example, Ethernet standard by the modem installed at the central equipment and the customer equipment, and the modulated signals are communicated as frequency-multiplexed optical signals.

For example, when the first optical coupler is installed at the central equipment, the modem installed in the central equipment modulates frequency of carrier waves assigned to each of the customer equipments and transmits the modulated signals through the first optical coupler directly to each customer equipment. The modem installed in the customer's network demodulates the modulated signals in the assigned and predetermined frequency band and receives data sent from the central equipment. On the contrary, when data signals are transmitted from the customer equipment, the modem installed in the customer's network modulates the carrier waves in a predetermined frequency band and transmits the modulated data to the first optical coupler in the central equipment. The modulated signals become frequency-multiplexed signals in the first optical coupler, and are then demodulated in the modem installed in the central equipment by using carrier waves which are assigned and have a predetermined frequency band. Accordingly, the central equipment can receive data sent from the customer equipment.

When the first optical coupler is placed at a branch point of the trunk optical fiber cable, the modem in the central equipment modulate the carrier waves of an assigned frequency band into frequency-multiplexed signals and send the signals to a conventional trunk optical fiber cable. The first optical coupler is installed at the branch point of the conventional trunk optical fiber cable, and the first optical coupler distributes/branches the frequency-multiplexed signals to each of the customer equipment. The frequency-multiplexed signals are demodulated in the modem in the customer's network by using carrier wave of the assigned and predetermined frequency, and as a result the customer equipment receives data signals, e.g., in Ethernet standard.

On the contrary, when data is transmitted from the customer equipment, the modem installed in the customer's network modulates carrier waves of the assigned and predetermined frequency band in, e.g., Ethernet standard and transmits the data signals through the branching fiber to the first optical coupler. The first optical coupler multiplexes the modulated signals from each customer equipment and sends the signals as frequency-multiplexed signals to the central equipment. Then the modem installed in the central equipment demodulate the modulated signals from each customer equipment by using carrier waves of the assigned and predetermined frequency band, to thereby distributing data from the customer equipment.

By applying such a network structure, the central equipment and each of the customer equipments are connected by optical fibers. In short, in the present invention, data signals transmitted from the central equipment may not be necessarily converted into electric signals in a repeater unit first and then again distributed to each line as in a conventional invention. Accordingly, the present network system does not require electric power supply to a repeater unit as in the conventional invention, which enables communication cost to be cheaper. And a passive type first optical coupler is used in the network of the present invention, which enables to supply high-speed communication. So at least data communication between the central equipment and the customer equipment becomes much faster in the present invention compared with data communication in a conventional invention. Also, data communication is carried out by frequency-division multiplex in the present invention, great amounts of data can be communicated simultaneously. That enables the network system to provide effective data communication.

A tenth aspect of the present invention provides an optical fiber network system according to the ninth aspect, wherein the central equipment comprises an image unit which generates image signals, and a mixer which mixes image signal and signal of frequency-division mutiplex.

In the optical fiber network system of the tenth aspect, the mixer placed in the central equipment mixes image signals from the image unit and frequency-multiplexed signals (modulated in Ethernet standard) and transmits to the customer equipment. As a result, the customer equipment can receive not only data signals but also image signals. Such a network system may be a useful and convenient optical fiber network system which can be applied for, e.g., a CATV network system. Here, image signals also include audio signals corresponding to image of the image signals. In concrete, image signals are TV signals, video signals, and so on.

An eleventh aspect of the present invention provide an optical fiber network system according to any one of the ninth and tenth aspects, comprising: a pair of second optical couplers which mix/separate optical signals having different wavelength; and one optical line connecting between the pair of second optical couplers, when the first optical coupler is installed at the branch point of the optical fiber network system, a pair of second optical couplers which mixes/separates optical signals having different wavelengths is installed at the downstream side of the central equipment and at the upstream side of the first optical coupler, or at the downstream side of the central equipment and at the upstream side of the customer equipment, sandwiching the first optical coupler with the former second optical coupler, the pair of second optical couplers are connected by one optical line, and data communication is carried out through the one optical line in a first predetermined wavelength to the downstream direction and in a second predetermined wavelength to the upstream direction.

In the network system of this aspect, a pair of second optical couplers are installed between the central equipment and the first optical coupler so that each of the second optical couplers face with each other, and the second optical couplers are connected with one optical line. And/Or in this network system, a pair of second optical couplers are installed at the downstream side of the central equipment and the upstream side of the customer equipment, sandwiching the first optical coupler. The pair of second optical couplers are connected with one optical line. In other words, the central equipment and the first optical coupler are connected by one optical line in the former network system, while the central equipment and the customer equipment, sandwiching the first optical coupler, are connected with one optical line in the latter network system. In the former network system, the one optical line is a trunk optical fiber. In the latter network system, the one optical line is a series of a trunk optical fiber, the first optical coupler, and a branching fiber.

The first optical coupler is also include an optical distributing device or an optical branching device which distributes or branches optical signals regardless of their wavelength. And the second optical coupler is a wavelength selecting device (directional filter) which separates optical signals to a predetermined direction.

In the above described network system, optical signals of a first predetermined wavelength are used in the downstream communication and optical signals of a second predetermined wavelength are used in the upstream communication.

When the second optical couplers are installed at the downstream side of the central equipment and at the upstream side of the first coupler, data signals from the central equipment are transmitted in a first predetermined wavelength (e.g., 1.3 μm). The optical signals of the first predetermined wavelength are then inputted by the second optical coupler installed at the downstream side of the central equipment to the trunk optical fiber and outputted from the other second optical coupler installed at the trunk so that both of the second optical couplers face with each other. Then the signals are sent to each customer equipment by the first optical coupler. On the contrary, optical signals of the second predetermined wavelength (e.g., 1.55 μm) transmitted from a customer equipment to the upstream direction pass through the branching fiber and are frequency-multiplexed in the first optical coupler. Then the signals are inputted through the second optical coupler to the trunk optical fiber, and to the other second optical coupler installed at the downstream side of the central equipment. The optical signals inputted to the second optical coupler are separated to a predetermined direction (the receiver side of the central equipment). Accordingly, signals from each of the customer equipments are received.

When the second optical couplers are installed at the downstream side of the central equipment and at the upstream side of the customer equipment, optical signals of the first predetermined wavelength transmitted from the central equipment to downstream direction pass through the second optical coupler placed at the downstream side of the central equipment, the trunk optical fiber, the first optical coupler, and the branching fiber, and are then inputted to the other second optical coupler installed at the upstream side of the customer equipment. The signals are branched by the second optical coupler and received by the receiver of the customer's network. On the contrary, optical signals of the second wavelength transmitted from the customer equipment to the upstream direction are inputted to the second optical coupler, the branching fiber, the first optical coupler, and the trunk optical fiber in sequence, and then to the second optical coupler installed at the downstream side of the central equipment. The inputted optical signals are separated by the second optical coupler to a predetermined direction (the receiver side of the central equipment) and received by the central equipment.

As described above, by employing a pair of second optical couplers, one optical line can do at least in the midstream of the network. That results in simplifying structure of an optical fiber network system. And, as a result, communication cost of the optical fiber network system can be reduced.

A twelfth aspect of the present invention is the central equipment in an optical fiber network system according to any one of the ninth to eleventh aspects, comprising an optical transmitter which transmits modulated signals to the customer equipment and an optical receiver which receives modulated signals from the customer equipment, further comprising: a line concentrator which mixes or distribute signals in Ethernet standard and transmits the signals; a modem installed at each input/output port of the line concentrator; a mixer which mixes modulated signals transmitted from each modem; and a band splitter which separates the modulated signals transmitted from the customer equipment and transmits the signals to the modem installed at each input/output port of the line concentrator.

The line concentrator mixes and transmits the upstream signals in Ethernet standard while it branches the downstream signals to input/output ports according to the address. The modems installed at each input/output port of the line concentrator modulate the branched signals in Ethernet standard and output the modulated signals. In short, the modem installed at each input/output port modulates carrier wave of assigned wavelength in Ethernet standard and then transmits the signals to the mixture. The mixture mixes the modulated signals from each port, converts them into frequency-multiplexed signals, and then outputs to the optical transmitter. That mixed signals are converted by the optical transmitter into optical signals and transmitted to the customer equipment placed at the downstream side of the optical transmitter.

On the contrary, frequency-multiplexed optical signals from the customer equipment are received by the optical receiver in the customer's network, converted into electric signals and inputted to the splitter. The splitter branches the frequency-multiplexed signals into carrier waves of each corresponding and predetermined frequency band and inputs the carrier waves into the corresponding modem installed at each input/output port. The modem demodulates the modulated signals by carrier waves of each predetermined frequency band, obtains signals in Ethernet standard, and transmits to each input/output port of the line concentrator. The line concentrator then mixes the data signals in Ethernet standard and transmits to the upstream side of the network.

By forming such a central equipment, the optical fiber network system according to the ninth to eleventh aspects can be easily constructed. Such central equipment enables to simplify plural conventional optical fiber network systems and improve data communication speed at least between the central equipment and each customer equipment.

A thirteenth aspect of the present invention is the central equipment in an optical fiber network system according to twelfth aspect, wherein the band splitter comprises a distributor and a filtering unit installed at the output port of the distributor.

The distributor distributes all the frequency-multiplexed signals transmitted from the customer equipment. The filtering unit (e.g., a band pass filter) installed at the output port of the distributor picks out signals having carrier waves of a predetermined frequency band and outputs the signals to the modem installed per each frequency band. That results in providing equivalent efficiency to the case of using a directional filter. The central equipment of the twelfth aspect can also be obtained by accordingly applying the splitter.

The fourteenth aspect of the present invention is the central equipment of the optical fiber network system according to any one of the twelfth and thirteenth aspects, wherein an interface equipment which communicates with external media is installed in the central equipment.

When the external media is Internet, the interface equipment is, for example, a router which interconnects different networks with each other. A router relays data to an addressed network according to the routing table in which each route is described. By forming such an interface equipment, a customer equipment can easily communicate with other external media such as Internet. As a result, an optical communication network which is more useful and convenient for a customer equipment can be obtained.

### BRIEF DESCRIPTION OF THE DRAWINGS

FIG. 1 is a schematic view of an optical fiber network system according to a first embodiment of the present invention.

FIG. 2 is a block diagram of a central equipment according to the first embodiment of the present invention.

FIG. 3A is a graph showing frequency band in the upward stream, and FIG. 3B is a graph showing frequency band in the downward stream according to the first embodiment of the present invention.

FIG. 4 is a block diagram of network environment of a customer equipment according to the first embodiment of the present invention.

FIG. 5 is a block diagram of network environment of other customer equipment according to the first embodiment of the present invention.

FIG. 6 is a graph of frequency band comprising home band according to the first embodiment of the present invention.

FIG. 7 is a schematic view of an optical fiber network system according to a second embodiment of the present invention.

FIG. 8 is a schematic view of an optical fiber network system according to a third embodiment of the present invention.

FIG. 9 is a schematic view of an optical fiber network system according to a modified embodiment of the first embodiment in the present invention.

FIG. 10 is a schematic view of an optical fiber network system in a conventional invention.

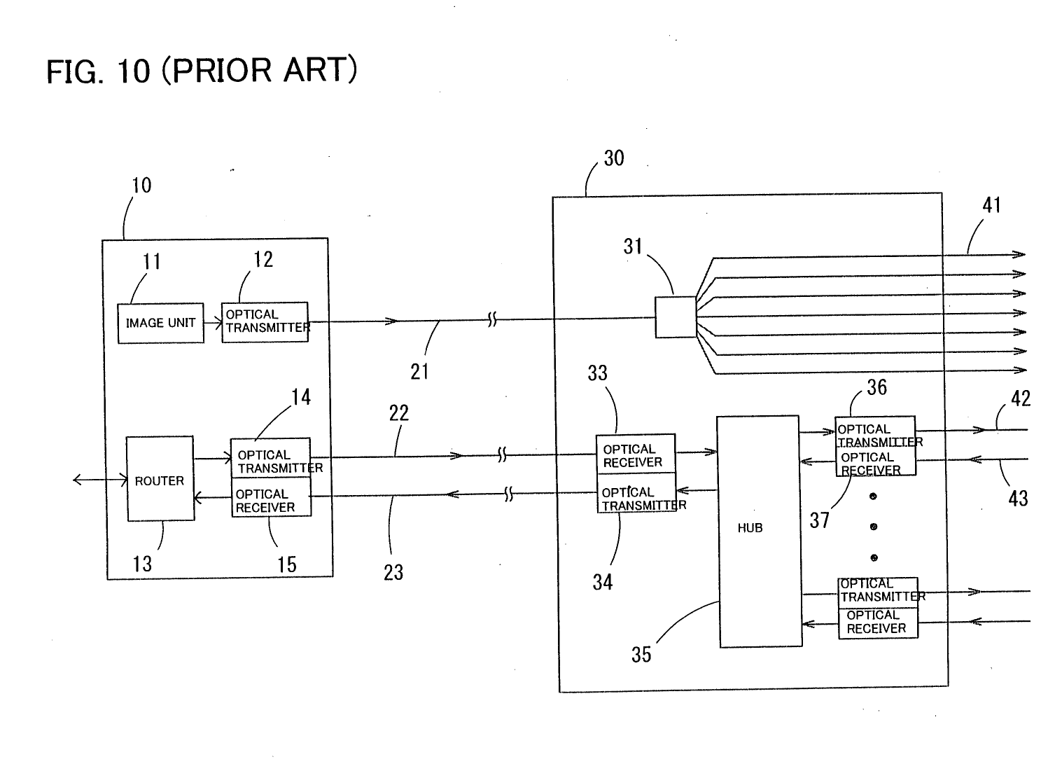

### BEST MODE FOR CARRYING OUT THE INVENTION

Embodiments of the present invention will next be described with reference to the drawings. Characteristic features of the present invention which have been described above is also the best mode for carrying out the invention, and the present invention is not limited to the below-described specific embodiments.

(First Embodiment)

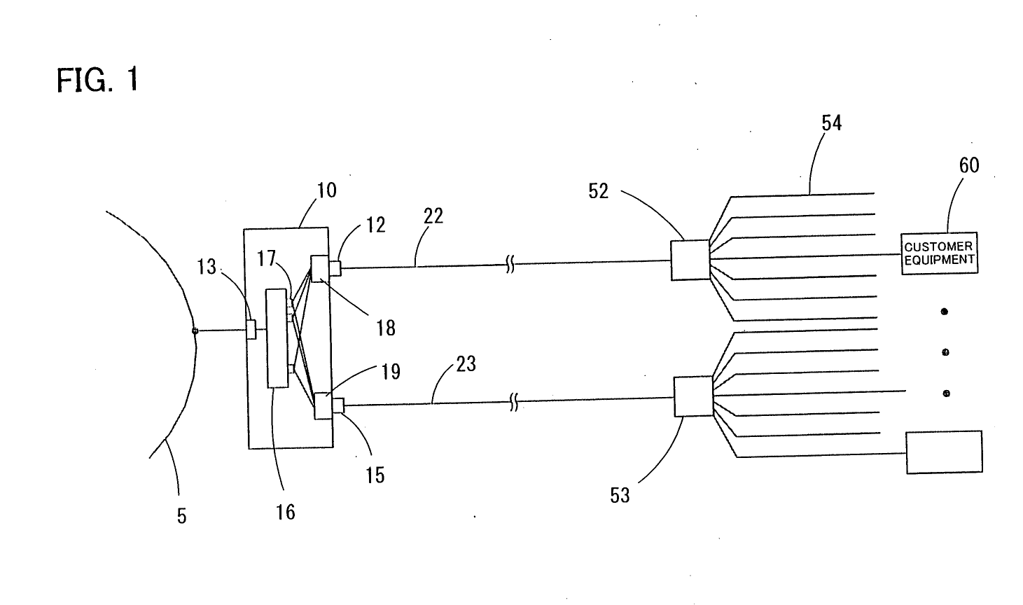

FIG. 1 shows an example of an optical fiber network system of the present invention. FIG. 1 illustrates an example when an optical fiber network system is applied to a CATV network system. The CATV optical fiber network system in this embodiment comprises: a central equipment 10; two optical fibers 22 and 23 which are extended from the central equipment 10; first optical couplers 52 and 53 which are directional branchers/distributors (repeater units) and connected at the other ends of the optical fibers 22 and 23, respectively; branching fibers 54 which are branched/distributed from the first optical couplers 52 and 53; and a customer equipment 60 which is connected at the end of the branching fiber 54. This optical fiber network system is a Passive Optical Network (PON) which requires no power supply in the transmission line. Because optical fibers are directly installed at the customer equipment 60's house, this network system is called FTTO (Fiber To The Office) or FTTH (Fiber To The Home). Details of the compositions in this network are described later.

In this system, downstream signal from the central equipment 10 is transmitted only through the optical fiber 22 and upstream signal from the customer equipment 60 is transmitted only through the optical fiber 23. Ordinary, the central equipment 10 is connected to an external network such as Internet 5. The downstream signal may include all data signals which a customer equipment uses and other signals, e.g., TV signals for satellite broadcasting and ground-based broadcasting, video signals for CATV, downstream data signals dedicated for CATV, and isochronous signals of the IEEE 1394 standard.

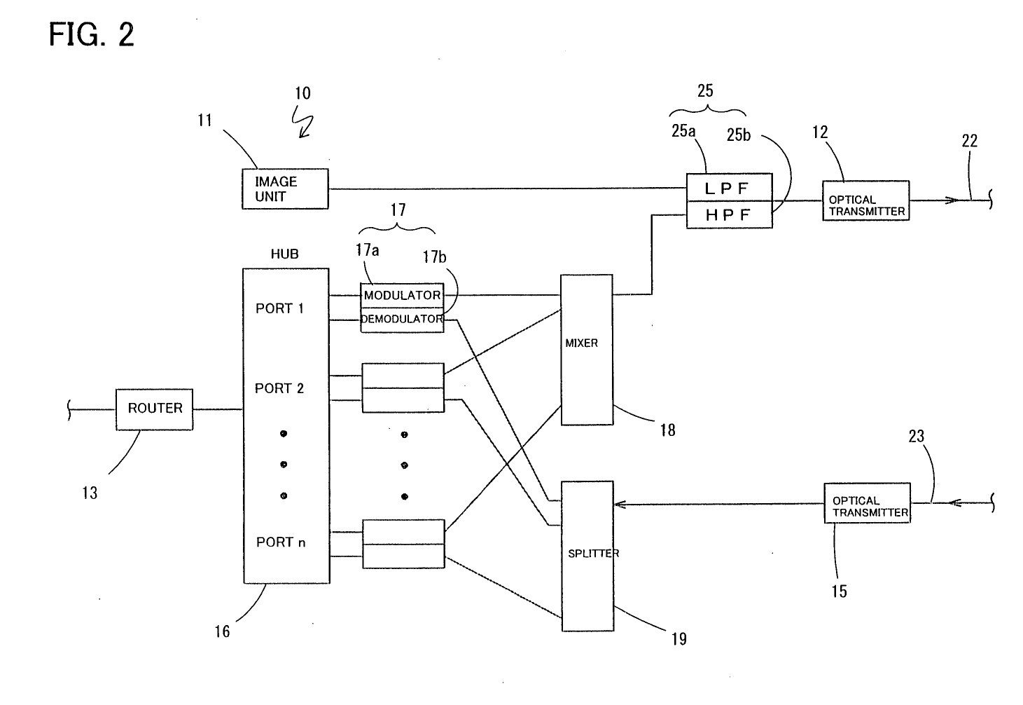

Next, each element consisting of the system described above is explained hereinbelow. FIG. 2 illustrates the structure of the central equipment 10. FIG. 2 is a block diagram illustrating the structure. The central equipment 10 in the present embodiment comprises an image unit 11, an optical transmitter 12, a repeater 13, an optical receiver 15, a hub 16 functioning as a line concentrator, plural modems 17, a mixer 18, a splitter 19, and a mixer 25. The modem 17 comprises a modulator 17a and a demodulator 17b.

The image unit 11 transmits image signals such as TV signals and video signals to each customer equipment. The hub 16 is a line concentrator which concentrates and distributes data signals in Ethernet standard. The router 13 is an interface equipment which connects the hub 16 to the other media such as Internet in Ethernet standard. The modulator 17a modulates carrier wave of a predetermined frequency into data in Ethernet standard which is distributed by the hub 16 and transmits the modulated carrier wave to the customer equipments. On the contrary, the demodulator 17b demodulates modulated data which is transmitted from the customer equipment 60 into data in Ethernet standard.

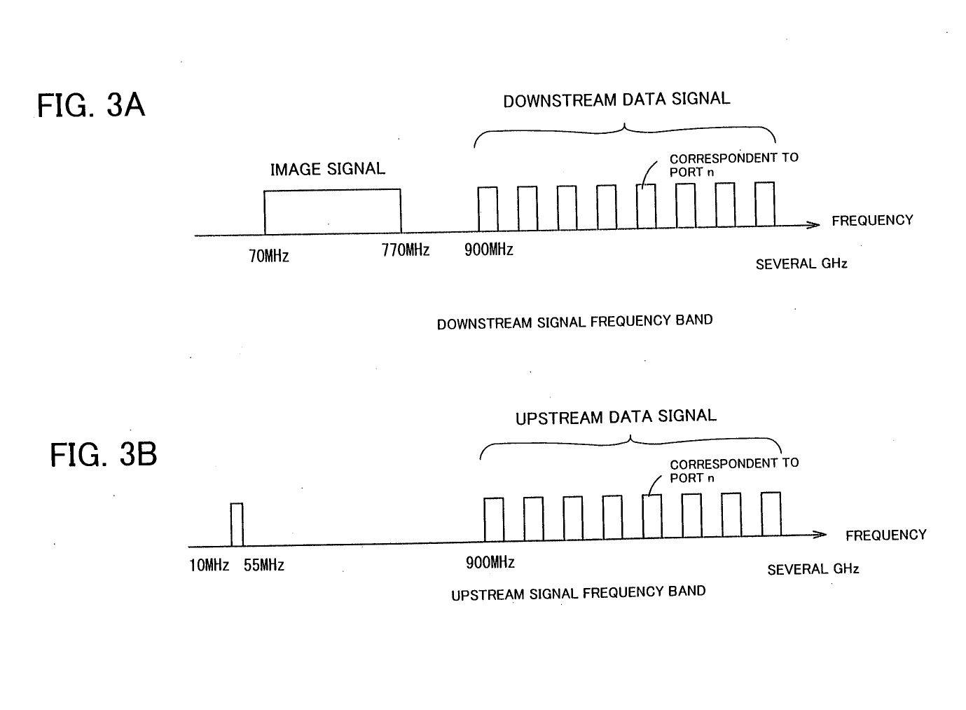

The mixer 18 is an equipment which mixes modulated signal transmitted from the modulator 17a, or an equipment which frequency-multiplexes. The splitter 19 splits frequency-multiplexed signals, which are transmitted from downstream (the customer equipment 60), into each predetermined frequency band and transmits each split signals to a corresponding demodulator 17b. The mixer 25 is a kind of filtering element comprising LPF 25a and HPF 25b. Image signals pass through the LPF 25a, frequency-multiplexed signals pass through the HPF 25b, and then both signals are mixed in the mixer 25. As shown in FIGS. 3A and 3B, frequency band of image signal is different from that of data signal. With respect to the downstream signals, image signals are transmitted in, for example, a frequency band of 70 MHz to 770 MHz while data signals are transmitted in a frequency band of 900 MHz to several GHz (FIG. 3A). With respect to the upstream signals, data signals are transmitted in a frequency band of 900 MHz to several GHz in addition to a conventional frequency band of 10 MHz to 50 MHz (FIG. 3B). The optical transmitter 12 is an equipment which converts mixed signals into optical signals and transmits the optical signals to the optical fiber 22. And the optical receiver 15 is an equipment which converts the optical signals (frequency-multiplexed signals) transmitted from the customer equipment 60 into electric signals.

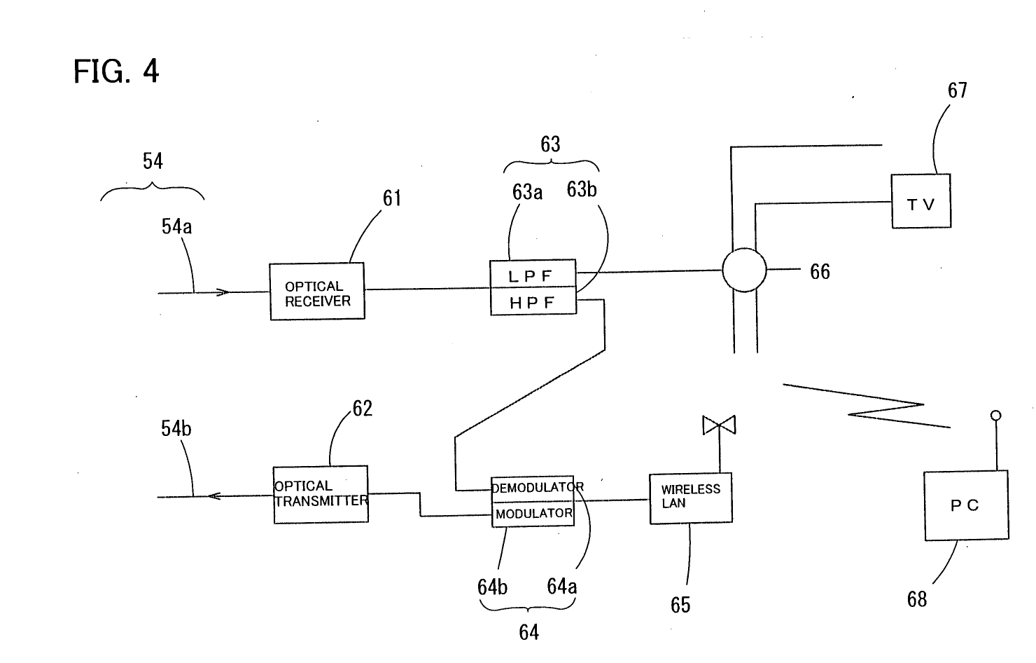

FIG. 4 illustrates the customer 60's network structure. The customer equipment 60 comprises an optical receiver 61 which receives modulated signals from the central equipment 10, an optical transmitter 62 which transmits modulated signals to the central equipment 10, a splitter 63 comprising LPF 63a and HPF 63b, a modem 64 comprising a demodulator 64a and a modulator 64b, a wireless LAN equipment 65, a distributor 66 which distributes TV signals, a TV signal receiver 67, and a wireless terminal equipment 68 such as a personal computer (PC). The splitter 63 splits image signals, or low-band signals, and frequency-multiplexed signals (data signals), or high-band signals. The wireless LAN equipment 65 is a server computer which controls wireless transmission of each wireless terminal equipment 68. Alternatively, the wireless LAN equipment 65 may be a wired LAN equipment. Then the customer equipment 60 may comprise a server computer and a terminal equipment for wire-fixed LAN.

Next, each element in this network is explained as shown in FIGS. 1-4. As in FIG. 2, when the hub 16 installed in the central equipment 10 receives data signals from the router 13 which is connected to Internet, the hub 16 reads address of the data and distributes the data to each input/output port correspondent to each address. Each port comprises the modem 17 each having different carrier wave frequency, in which carrier wave having a predetermined frequency is modulated by the distributed data and the modulated signals are transmitted to the mixer 18 in a frequency band shown in FIG. 3A. As the modulation method, phase-modulation (e.g., PSK) method may be employed. Because PSK method only varies phase of the signals, their spectrum is not so much broadened and that enables to transmit data with using frequency band more efficiently. Further, by employing PSK method, data transmission is hardly affected by signal level fluctuation and noise.

The mixer 18 mixes modulated signals transmitted from each modulator 17a, multiplexes their frequency and transmits them to the mixer 25. The mixer 25 mixes the image signals and the frequency-multiplexed signals and then sends the mixed signal to the optical transmitter 12. The optical transmitter 12 then transmits the signals to the downstream of the network through the optical fiber 22. A first optical coupler 52 is attached at a branch point of the optical fiber 22 and it branches/distributes the optical signals to the customer equipment 60 (FIG. 1).

The customer equipment 60 receives the mixed signals (TV signals+frequency-multiplexed signals) through the optical fiber 54a and the optical receiver 61 (FIG. 4). The frequency-multiplexed signals, or high-band signals, are demodulated by the demodulator 64a into data signals in Ethernet standard. The mixed signals are not demodulated if the signals have carrier wave frequency different from that of the demodulator 64a. The wireless LAN equipment 65 transmits the demodulated data signals to the wireless terminal equipment 68. Each wireless terminal equipment 68 checks the address of the data, and receives the data when their address matches to the predetermined address assigned to the terminal equipment 68. Data transmission in downstream direction is carried out as explained above. TV signals mixed and transmitted with the data signals pass through LPF 63a in the splitter 63, are distributed by the distributor 66 attached in the customer 60's network and received by the TV set 67.

In the upstream side of the network, data transmission is carried out in the reverse route in the downstream side. That is, data signals from the wireless terminal equipment 68 of the customer equipment 60 are inputted to the wireless LAN equipment 65 and then to the modulator 64b comprised in the modem 64. The modulator 64b modulates the carrier wave, whose frequency is assigned to the modulator 64b, by the inputted data and transmits the modulated data to the optical transmitter 62. The optical data signals forwarded from the optical transmitter 62 are mixed in the first optical coupler 53 installed on the optical fiber 54b with the optical signals forwarded from each of the other customer equipments 60 and transmitted through the optical fiber 23 to the optical receiver 15 installed in the central equipment 10 (FIG. 1). The data signals are converted through photoelectric conversion in the optical receiver 15, split in accordance with each predetermined frequency in the splitter 19, and each of the split data is transmitted to the respective demodulator 17b installed in the modem 17 (FIG. 2). The demodulator 17b demodulates the modulated signals into data signals by the respective predetermined frequency, to thereby provide data in Ethernet standard. The hub 16 transmits the data to the router 13 attached in the upstream side of the network, and the router 13 transmits the data to, for example, Internet 5. Data transmission in upstream direction is carried out as explained above.

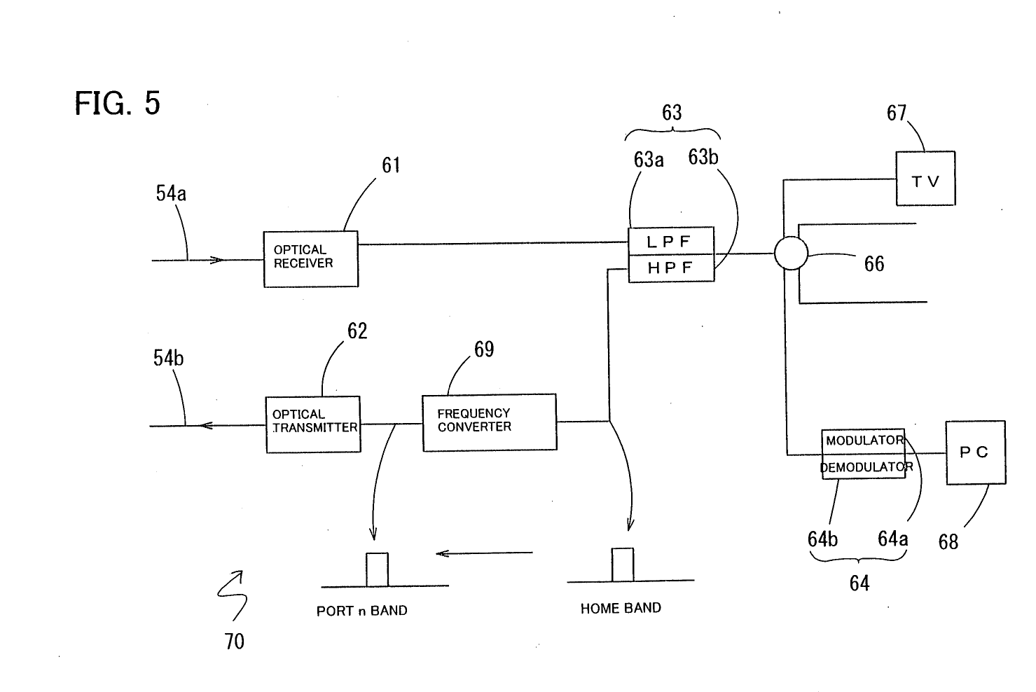

The customer equipment 60 (FIG. 4) may have other network structure. For example, the customer equipment 60 may be replaced by a customer equipment 70 shown in FIG. 5. FIG. 5 is a block diagram illustrating the network structure of the customer equipment 70. The customer equipment 70 comprises an optical receiver 61 which receives modulated signals from a central equipment 10, an optical transmitter 62 which transmits modulated signals to the central equipment 10, a splitter 63 which comprises LPF 63a and HPF 63b, a modem 64 which comprises a demodulator 64a and a modulator 64b, a frequency converter 69 which converts the frequency band used in home (hereinafter “home band”) into the frequency band assigned to the port n (hereinafter “port ‘n’ band”), a distributor 66 which distributes TV signals, a TV set 67, and a terminal equipment 68 such as a personal computer (PC).

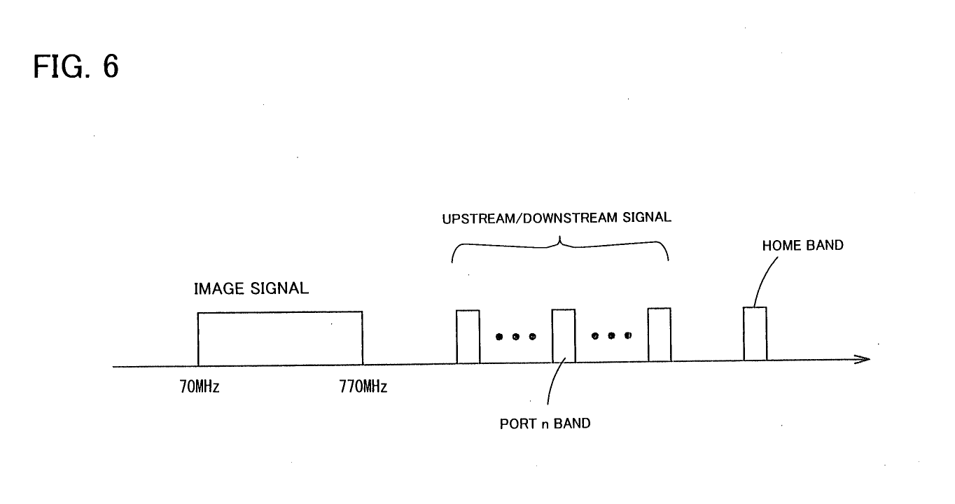

Data transmission in the downstream direction from the central equipment 10 is carried out in the same process as that of the customer equipment 60. Image signals such as TV signals pass through the LPF 63a installed in the splitter 63 and are received by the TV set 76. On the contrary, the upstream signals from the terminal equipment 68a is transmitted by using the home band shown in FIG. 6. Here the home band may be a frequency band which is commonly used in a domestic LAN. In this embodiment, the modem 64 transmits data converted in Ethernet standard by using the home band. The data signals pass through the HPF 63b installed in the splitter 63 and are inputted to the frequency converter 69. The frequency converter 69 converts the inputted signal of the home band into the signal to have predetermined frequency band, or the assigned port ‘n’ band, and sends the data signal to the central equipment 10. The network of the customer equipment 70 may have such a structure. Any network structure may do as long as assigned and predetermined frequency band is used and frequency-multiplexed data transmission is carried out in input/output part of the customer 70's network. So frequency band used for data transmission in the customer 70's network may not be limited.

As explained above, the present invention employs an optical coupler in an optical fiber network in order to provide a PON (Passive Optical Network). Carrier waves in multiple frequency bands are assigned to each customer equipment, and frequency-multiplexed optical signals are transmitted by using the carrier waves. Accordingly, it is not necessary to install a hub in a separator to separate data electrically as in the conventional invention. Because optical data is transmitted in throughout the downstream route from the central equipment to the customer equipment without being converted, higher-speed data communication compared with the conventional data communication can be realized. Moreover, because no electrical power supply is needed in a repeater, cost for the data communication can be reduced in the present invention. And because the data signals are transmitted along with image signals, both signals can be utilized. Accordingly, an optical communication network which is more useful and convenient for a customer equipment to receive data can be obtained.

(Second Embodiment)

In the first embodiment, an optical communication network in which each of two optical fibers extended from the central equipment are branched/distributed by a first coupler is disclosed. In the second embodiment, wavelength of the optical signals in the upstream direction is arranged to be different from that of the optical signals in the downstream direction and communication of the optical signals in both directions are carried out through one optical fiber. That is, wavelength division multiplex optical network is explained in the second embodiment.

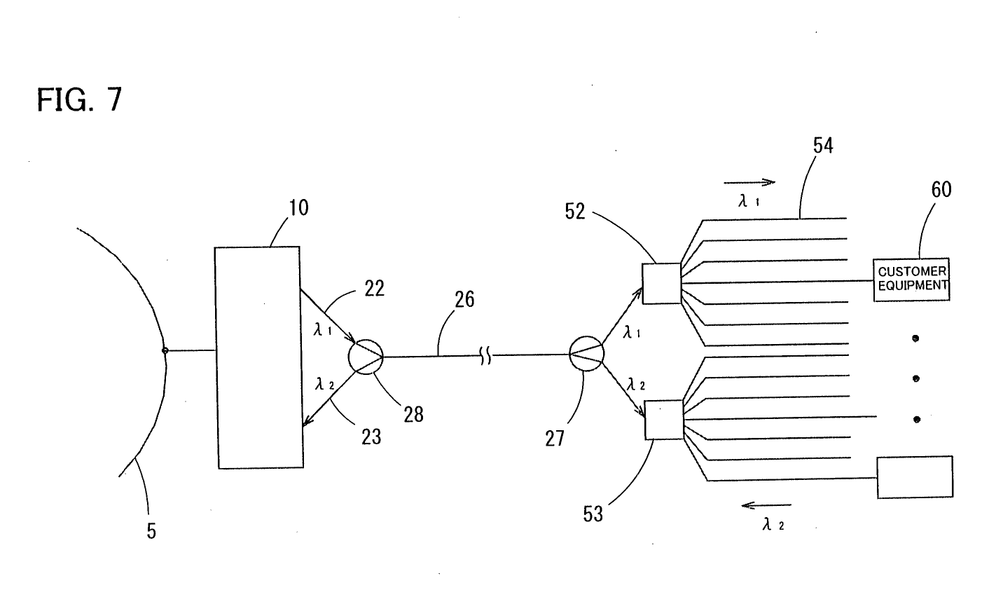

FIG. 7 shows a CATV optical fiber network system in the second embodiment. The CATV optical fiber network system in this embodiment comprises: a central equipment 10; optical fibers 22, 23, and 26; second optical couplers 27 and 28; first optical coupler 52 and 53; and a customer equipment 60. A pair of the second optical couplers 27 and 28 are installed between the central equipment 10 and the first optical couplers 52 and 53, and the second optical couplers 27 and 28 are connected by the optical fiber 26, which make the network system in the second embodiment different from that in the first embodiment. The first optical couplers 52 and 53 are optical devices which branch/distribute optical signals having any wavelength. On the contrary, the second optical couplers 27 and 28 are directional filters which separate optical signals having predetermined wavelength to the predetermined direction.

And the optical transmitter 12 transmits optical signals having a first predetermined wavelength (λ₁=1.3 μm) shown in FIG. 2 from the central equipment 10 to the customer equipment 60. The second optical coupler 28 inputs the optical signals transmitted to the downstream side of the network into one optical fiber 26 and then into the second optical coupler 27. The second optical coupler 27 is a filter discriminating signals according to wavelength. The optical signals of the first predetermined wavelength is separated by the second optical coupler 27 to the first optical coupler 52 side, and transmitted to the customer equipment 60 through the first optical coupler 52 and the branching fiber 54. Here the network system of the customer equipment 60 is same as that of the customer equipment 60 in the first embodiment.

And the optical signal having different wavelength, or a second predetermined wavelength (λ₂=1.55 μm), is transmitted from the transmitter of the customer equipment 60. The optical signal having the second predetermined wavelength and transmitted from the customer equipment 60 is mixed with other optical signals from other customer equipments 60 in the first optical coupler 53 and sent to the second optical coupler 27. Because the second optical coupler 27 is a directional filter, the optical signals of the second predetermined wavelength are transmitted to the upstream side of the network. In short, the optical signals having the second predetermined wavelength are inputted through one optical fiber cable 26 to the second optical coupler 28 functioning as a directional filter.

The second optical coupler 28 separates the optical signals of the second predetermined wavelength to the receiver side of the central equipment 10 and inputs the signals into the optical receiver 15 installed in the central equipment 10. The central equipment 10 of the present embodiment carries out the same data communication as in the first embodiment.

By applying such a network structure, at least data transmission line connecting the central equipment 10 and the first optical couplers 52 and 53 can be only one optical fiber. That enables to simplify the optical fiber network system. In short, that results in reducing communication costs.

(Third Embodiment)

In the second embodiment, a pair of the second optical couplers are installed, one at the downstream side of the central equipment and the other at the upstream side of the first couplers, and one optical fiber connect the two second optical couplers with each other. That is, the main is formed of one optical fiber by using one pair of the second optical couplers are connected by using one optical fiber with each other while an optical fiber to the upstream direction and an optical fiber to the downstream direction, or two optical fibers in total, are connected to a customer equipment. Also, the second embodiment is about a network system in which a first optical coupler functions as a optical splitter.

In the third embodiment, a pair of second optical couplers are installed at the downstream side of the central equipment and at the upstream side of the customer equipment, facing with each other. That is, a pair of second optical couplers are installed sandwiching a first optical coupler so that not only the main line of the network but also the branching fiber to a customer equipment can be collected to be one fiber.

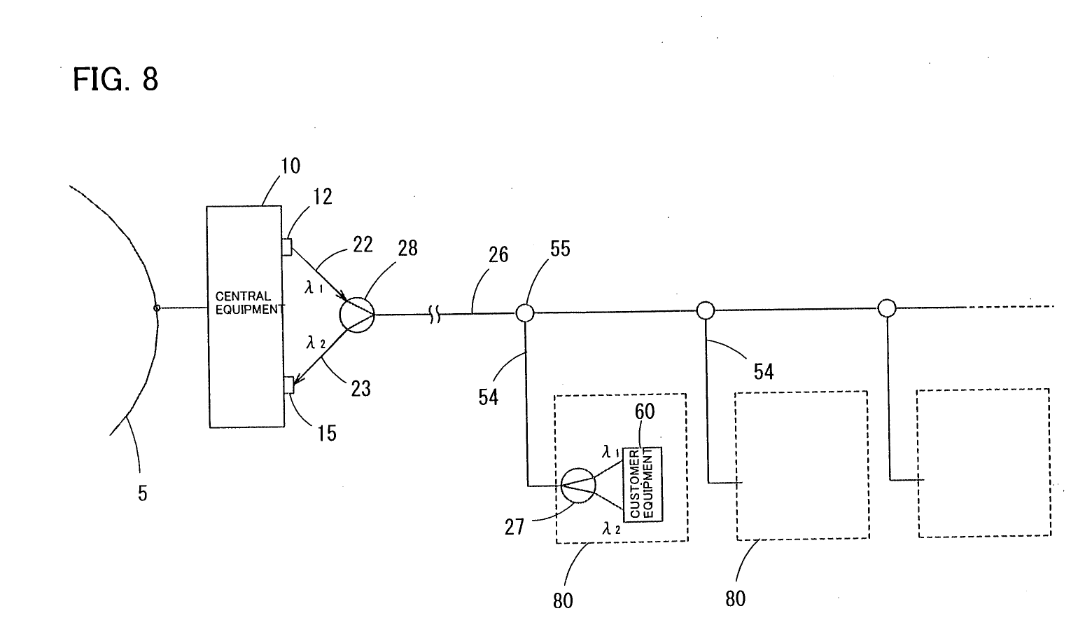

FIG. 8 illustrates a CATV optical fiber network system of the third embodiment. The CATV optical fiber network system of the third embodiment comprises: a central equipment 10; optical fibers 22, 23, and 26; second optical couplers 27 and 28; a first optical coupler 55; and a customer equipment 60. The first optical coupler functions as an optical splitter and the second optical couplers 28 and 27 are installed at the downstream side of the central equipment 10 and at the upstream side of the customer equipment 60, respectively, which make the network system in the third embodiment different from that in the second embodiment. And the second optical couplers 28 and 27 are connected by the optical fiber 26, the first optical coupler 55, and the branching fiber 54. When the customer equipment 60 in whose network the second optical coupler 27 is installed is represented by a customer equipment 80? the customer equipments 80 are connected to other first optical couplers 55 through the other branching fibers 54, respectively.

In this network, as in the second embodiment, the optical transmitter 12 transmits optical signals having a first predetermined wavelength (λ₁=1.3 μm) from the central equipment 10 to the customer equipment 60. The optical signals are transmitted to the downstream side of the network through the optical fiber 22, the second optical coupler 28, the optical fiber 26, the first optical coupler 55, the branching fiber 54, and the second optical coupler 27 in sequence. The second optical coupler 27 is a filter discriminating signals according to wavelength. The optical signals of the first predetermined wavelength is separated by the second optical coupler 27 and transmitted to the customer equipment 60. Here the network system of the customer equipment 60 is same as that of the customer equipment 60 in the first and second embodiments.

And optical signals having different wavelength, or a second predetermined wavelength (λ₂=1.55 μm), are transmitted from the transmitter of the customer equipment 60. The optical signals having the second predetermined wavelength and transmitted from the customer equipment 60 and inputted through the second optical coupler 27, the branching fiber 54, and the first optical coupler 55. In the first optical coupler 55, the optical signal is mixed with other optical signals from other customer equipments 60 in the first optical coupler 55 and inputted through the fiber 26 to the second optical coupler 28. Because the second optical coupler 28 is a directional filter, the optical signals of the second predetermined wavelength are received by the optical receiver installed in the central equipment 10. The central equipment 10 of the present embodiment carries out the same data communication as in the first and second embodiments.

By applying such a network structure, the central equipment 10 and the customer equipment 60 can be connected by only one optical fiber through the first optical coupler 55. That enables to simplify the optical fiber network system. In short, that results in reducing communication costs.

(Modified Embodiment)

Some examples explaining the present invention are described above. Moreover, there may be various other modified embodiments of the present invention. In the first embodiment, phase modulation is employed as modulation method of frequency-multiplexed signals. But other method may be employed. For example, phase modulation method and frequency modulation method may be employed as modulation method of frequency-multiplexed signals. When an amplitude shift keying (ASK) method is employed, envelope detection can be carried out, and that enables modulation of signals easier. A frequency shift keying (FSK) modulation method is hardly affected by signal level fluctuation and noise, which helps to obtain stable data modulation.

Alternatively, a combination of ASK method and PSK method in the first embodiment, or APSK method, may be employed. APSK method is a method of modulating amplitude and phase simultaneously. Because APSK method can assign data signals to two-dimensional signal spaces, or amplitude and phase, efficiency of utilizing frequency can be improved. In the above embodiments, ASK method, FSK method, and PSK method employ binary modulation. Alternatively, those methods may employ multivalued modulation. That enables to narrow the interval between each band, resulting in increasing the number of branching/distributing lines, or increasing the number of customer equipments. That is, such a network can communicate with much more customer equipments.

Alternatively, only the upstream line may be formed to transmit frequency-multiplexed signals and each band is assigned to each customer equipment. Further alternatively, unoccupied band may be assigned to each customer equipment. And also transmission through the downstream line may employ time division multiplex. Time division multiplex may distribute the time slot to each customer equipment, distribute unoccupied band to each customer equipment, and employ communication method such as packet transfer communication.

In the first to third embodiments, frequency of carrier wave is fixed to assign to the customer equipment 60. Alternatively, frequency of carrier wave may not particularly be fixed. Data communication between the central equipment 10 and the customer equipment 60 is not always-on connection, and there is a time when the assigned frequency band of carrier wave is not occupied. So generally unoccupied band (channel) is searched and used for communication in a common network system. That may be applied to the present embodiments. Because that does not fix carrier wave frequency band for customer equipments, more customer equipments can connect to such a network system.

In the first to the third embodiments, the central equipment 10 comprises the splitter 19 which splits signals transmitted from the customer equipment 60 in a predetermined frequency. Alternatively, a distributor and a filtering unit may be installed in the central equipment 10. First frequency-multiplexed signals transmitted from the customer equipment 60 are distributed by the distributor, and then they are separated into signals in a predetermined frequency by the filtering unit such as a band pass filter, which is installed at the downstream side of the central equipment 10. As a result, almost equivalent result can be obtained.

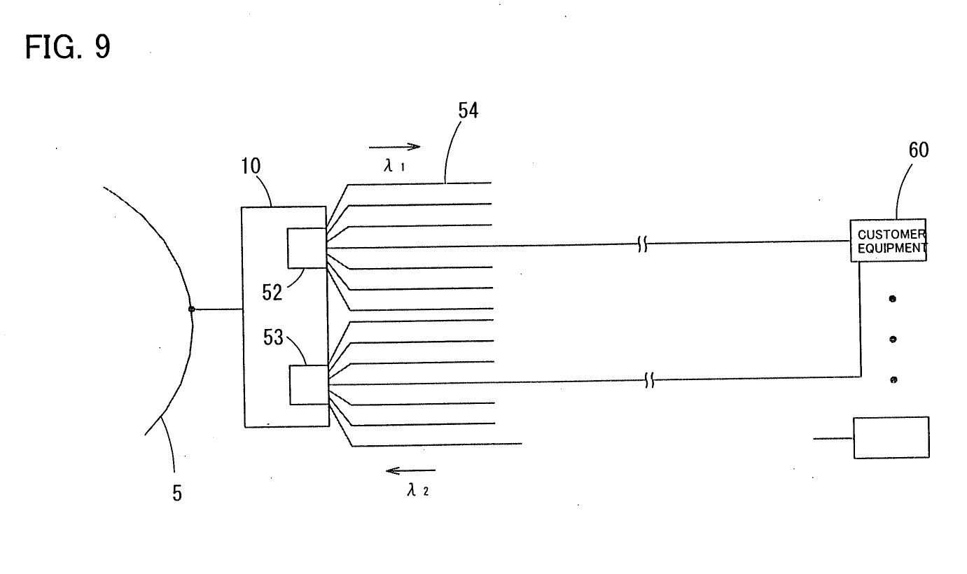

In the first embodiment, the first optical couplers 52 and 53 are installed at each branch point of the optical fibers 22 and 23, respectively. Alternatively, the first optical couplers 52 and 53 may be installed in the central equipment 10 as shown in FIG. 9. The network system of the present invention which distributes a predetermined wavelength to each customer equipment 60 and communicates with frequency-multiplexed signals may also be useful for a passive optical network in which the first optical couplers 52 and 53 directly branch the signals transmitted from the central equipment 10.

In the first to third embodiments, the downstream signals of CATV network whose frequency is in a range of 70 MHz to 770 MHz are frequency-multiplexed analogue signals. Alternatively, the signals may not necessarily be limited to analogue signals, but may be image signals of time-multiplexed digital signals. For example, signals may be transferred as base band signals by using isochronous transfer in IEEE 1394 standard. The point is that frequency bands except for the conventional image signal bands are distributed to each customer equipment and that signals are transmitted in a predetermined frequency band as frequency-multiplexed signals in an optical fiber network system. Communication method in the conventional bands may not be important.

1. A communication method of optical fiber network system connecting a central equipment and plural customer equipments, comprising:
a first optical coupler at a branch point of said central equipment and/or optical fiber network system, wherein
said first optical coupler branches/distributes optical fiber to said customer equipments,
carrier waves having multiple bands are prepared at least in the upstream route of said optical fiber network system and each is assigned to each of said customer equipments, and
said customer equipments modulate said carrier waves of assigned bands into Ethernet standard and transmit said carrier waves in frequency-division multiplex to the upstream route through said first optical coupler, respectively.

2. A communication method of optical fiber network system according to claim 1, wherein said central equipment modulates carrier wave of a predetermined band in those of multiple bands into Ethernet standard and transmits frequency-multiplexed signals through the downstream route.

3. A communication method of optical fiber network system according to claim 2, wherein said central equipment and said customer equipments search an unoccupied band from said multiple bands and use said carrier wave of the unoccupied band to transmit signals in said frequency-division multiplex.

4. A communication method of optical fiber network system according to claim 2, wherein each of said multiple bands is assigned and fixed to each of said customer equipments and said central equipment and said customer equipment use carrier wave of said assigned and predetermined frequency to transmit said signals in said frequency-division multiplex.

5. A communication method of optical fiber network system according to claim 1, wherein modulation method of said frequency-division multiplex is any one of amplitude modulation method, frequency modulation method, or a combination of those methods.

6. A communication method of optical fiber network system according to claim 1, wherein said central equipment mixes said signals of said frequency-division multiplex modulated in Ethernet standard with other downstream signals.

7. A communication method of optical fiber network system according to claim 1, when said first optical coupler is installed at said branch point of said optical fiber network system,
a pair of second optical couplers which mixes/separates optical signals having different wavelengths is installed at the downstream side of said central equipment and at the upstream side of said first optical coupler, or at the downstream side of said central equipment and at the upstream side of said customer equipment, sandwiching said first optical coupler with the former second optical coupler,
said pair of second optical couplers are connected by one optical line, and
data communication is carried out through said one optical line in a first predetermined wavelength to the downstream direction and in a second predetermined wavelength to the upstream direction.

8. A communication method of optical fiber network system according to claim 2, when said first optical coupler is installed at said branch point of said optical fiber network system,
a pair of second optical couplers which mixes/separates optical signals having different wavelengths is installed at the downstream side of said central equipment and at the upstream side of said first optical coupler, or at the downstream side of said central equipment and at the upstream side of said customer equipment, sandwiching said first optical coupler with the former second optical coupler,
said pair of second optical couplers are connected by one optical line, and
data communication is carried out through said one optical line in a first predetermined wavelength to the downstream direction and in a second predetermined wavelength to the upstream direction.

9. A communication method of optical fiber network system according to claim 1, wherein said central equipment transmits signals in time-division multiplex with respect to the downstream signal routes of said optical fiber network system.

10. A communication method of optical fiber network system according to claim 3, wherein said central equipment transmits signals in time-division multiplex with respect to the downstream signal routes of said optical fiber network system.

11. A communication method of optical fiber network system according to claim 7, wherein said central equipment transmits signals in time-division multiplex with respect to the downstream signal routes of said optical fiber network system.

12. An optical fiber network system comprising a central equipment and customer equipments, which comprises:
a first optical coupler installed at said central equipment and/or a branch point of an optical fiber extended from said central equipment;
a branching fiber extended from said first optical coupler; and
modems installed at said central equipment and each of said customer equipments, each of which transmits signal by each of carriers assigned to the respective customer equipments in frequency-division multiplex through said first optical coupler.

13. An optical fiber network system according to claim 12, wherein said central equipment comprises an image unit which generates image signals, and a mixer which mixes signals of image signal and signal of frequency-division multiplex.

14. An optical fiber network system according to claim 10, comprising:
a pair of second optical couplers which mix/branch optical signals having different wavelengths; and
one optical line connecting between said pair of second optical couplers,
when said first optical coupler is installed at said branch point of said optical fiber network system,
a pair of second optical couplers which mixes/separates optical signals having different wavelengths is installed at the downstream side of said central equipment and at the upstream side of said first optical coupler, or at the downstream side of said central equipment and at the upstream side of said customer equipment, sandwiching said first optical coupler with the former second optical coupler, and
said pair of second optical couplers are connected by one optical line.

15. A central equipment in an optical fiber network system according to claim 12, comprising an optical transmitter which transmits modulated signals to said customer equipments and an optical receiver which receives modulated signals from said customer equipments, further comprising:
a line concentrator which mixes or distribute signals in Ethernet standard and transmits the signals;
a modem installed at each input/output port of said line concentrator;
a mixer which mixes modulated signals transmitted from each modem; and
a band splitter which separates the modulated signals transmitted from said customer equipments and transmits the signals to said modem installed at each input/output port of said line concentrator.

16. A central equipment in an optical fiber network system according to claim 15, wherein said band splitter comprises a distributor and a filtering unit installed at the output port of said distributor.

17. A central equipment in an optical fiber network system according to claim 16, wherein an interface equipment which communicates with external media is installed in said central equipment.
